(19) United States
(12) Patent Application Publication
(10) Pub. No.: US 2001/0047299 A1
(43) Pub. Date: Nov. 29, 2001

(54) Rebate calculator

(76) Inventors: Sherran Irene Brewer, Cary, NC (US); Kim I. Marburger, Northville, MI (US); Mark A. Sabatelli, Raleigh, NC (US); Wilbur Randolph Stafford, Raleigh, NC (US)

Correspondence Address: DAVID J LEVY, CORPORATE INTELLECTUAL PROPERTY, GLAXOSMITHKLINE, FIVE MOORE DR., PO BOX 13398, DURHAM, NC, 27709-3398, US

(21) Appl. No.: 09/829,656

(22) Filed: Apr. 10, 2001

Related U.S. Application Data
(60) Provisional application No. 60/196,441, filed on Apr. 11, 2000.

(51) Int. Cl. G06F 17/60

(52) U.S. Cl. 705/14

(57) ABSTRACT

A method and system for analyzing at least one of (1) a compliance of a party with a contract and (2) potential rebate opportunities. In the environment of a drug rebate program, a manufacturer may award rebates for utilization of a predetermined amount of a drug, either in absolute terms or in terms of a market share. By allowing purchasers to see how close they are to achieving goals, purchasers may elect to increase the amount of goods purchased.

### CROSS REFERENCE TO CO-PENDING APPLICATIONS

The present application claims priority to and is related to co-pending U.S. Provisional Application serial No. 60/196,441 filed Apr. 11, 2000 the contents of which are incorporated herein by reference.

### BACKGROUND OF THE INVENTION

1. Field of the Invention

The present invention relates to a method, system and computer program product for calculating compliance with a contract. In one embodiment of the present invention, a method, system and computer program product calculate rebates due to one or more organizations based on having reached targeted goals.

2. Discussion of the Background

The establishment of contracts for prescription drugs between (1) distributors and/or manufacturers and (2) participants (e.g., hospitals, HMOs and other organizations) is becoming increasingly complex. Part of the complexity is due to the combination of participants into one or more hierarchical groups. For example, hospitals in a geographic region may join together to create a contract covering the cost of one or more drugs with a manufacturer or distributor. Similarly, an HMO in a particular region may create a contract with a manufacturer or distributor to cover a group of hospitals in one area and individual hospitals in another area.

As with any commercial endeavor, the cost of goods is a factor in the business relationship. The manufacturer or distributor does not want to lower cost unless it is can make up the “lost profit” on increased volume. Likewise, a participant does not want to be stuck with a high cost if it is going to order a high volume of products. Accordingly, as a vehicle to mitigate this business issue, drug distribution contracts have often included “rebates” which are premised upon a participant achieving certain targeted goals.

Rebates earned have been based on calculations after a specific rebate time period. These calculations have been a vehicle to only report what was earned during the period rather than a vehicle to affect actual performance during the period.

### SUMMARY OF THE INVENTION

It is an object of the present invention to track a participant's activities relating to a contract (e.g., a sales contract) to determine at least one of: (1) compliance with the contract and (2) eligibility of the participant for a rebate.

It is another object of the present invention to present sufficient information to the participants to adjust their buying behavior where possible.

As such, the present invention addresses a deficiency in known systems that utilize a “report card” of how a participant performed during a period but that do not provide a true opportunity to affect the participant's buying decision during the rebate period. The availability of timely market share information used in the calculation has precluded providing an actionable view of contract performance. That market share information is provided from a third party (e.g., Drug Distribution Data from IMS America) and is roughly 60 days old once received.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a schematic illustration of a computer for providing the services of the present invention;

FIG. 2 is a schematic illustration of various components used in a computer embodiment of the present invention;

FIG. 3 is a flow chart showing how data is distributed and processed according to one aspect of the present invention;

FIG. 4 is a data flow diagram showing how data is distributed and processed by various components of the present invention;

FIG. 5 is a schematic illustration of how data is distributed and processed by various components of the present invention;

FIG. 6 is a workflow chart showing where various data is generated and processed according to the present invention;

FIG. 7 is a tabular report showing projected rebates for a participant;

FIG. 8 is a tabular report showing contract compliance for a participant;

FIG. 9 is a tabular report showing a rebate opportunity for a participant;

FIG. 10 is a tabular report showing a rebate history for a participant;

FIG. 11 is a tabular report showing a “what-if” rebate analysis for a participant;

FIG. 12 is a screenshot of a spreadsheet showing a current tier analysis as compared to adjacent tiers above and below the current tier;

FIG. 13 is an exemplary starting Web interface for allowing a customer to examine purchasing goals and “what-if” scenarios;

FIG. 14 is a screenshot of an exemplary interface for selecting which group to display projected contract values or rebates;

FIG. 15 is a screenshot of an exemplary interface for selecting which subgroup of the group selected in FIG. 14 to display projected contract values or rebates;

FIG. 16 is a partially redacted screenshot of an exemplary interface for displaying projected contract values for the sub-group selected in FIG. 15;

FIG. 17 is a partially redacted screenshot of an exemplary interface for displaying projected rebate values for the sub-group selected in FIG. 15; and

FIG. 18 is a partially redacted screenshot of an exemplary interface for displaying rebate opportunities that may affect a customer's buying decision.

### DESCRIPTION OF THE PREFERRED EMBODIMENTS

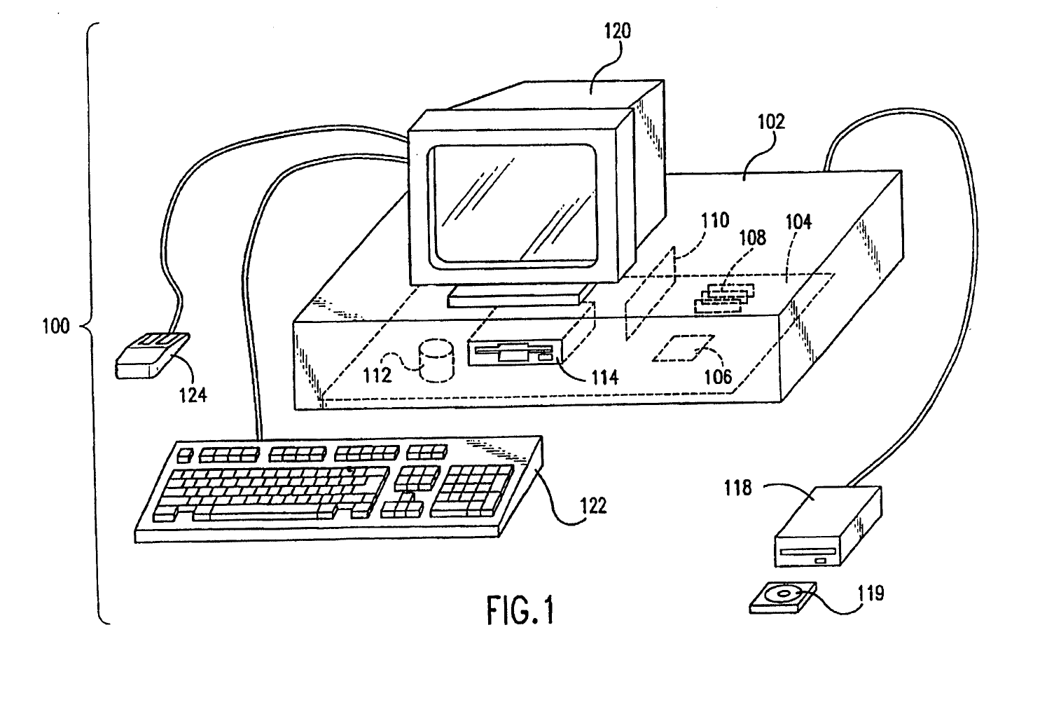

Referring now to the drawings, in which like reference numerals designate identical or corresponding parts throughout the several views, FIG. 1 is a schematic illustration of a computer system for providing measurement of compliance with a contract across a wide area network (e.g., the Internet). A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings of the achieved or projected goals.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. In the broadest sense, even the transmission lines of computer network adapters (e.g., modems, Ethernet, token ring and ATM) are computer readable media since code and/or data may be read from them. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for providing compliance measurements. The computer code devices of the present invention can be any interpreted or executable code mechanism, including but not limited to scripts (including Active Server pages or Java Server pages), interpreters, dynamic link libraries, Java classes, spreadsheets with or without macros, and complete executable programs. These computer code devices may run on either one of, or on a combination of, a client and a server computer.

According to the present invention, sales agreements (e.g., in the hospital customer segment) may be negotiated to have a discount component called a rebate that is premised upon the performances of the contract holder (hereinafter “the participant,” even for hierarchical aggregates) in achieving the targeted goals of the contract agreement. The rebate earned is generally measured by the growth in a product market share and is computed against the contract sales (e.g., as determined by the chargebacks data as submitted by a customer (e.g., direct customers or wholesalers). Rebate payment is a cyclical process and is scheduled on a periodic (e.g., a semi-annual or annual basis) as detailed in the contract.

Accordingly, a participant is provided with sufficiently current data to affect buying decisions that optimize its achievement of rebates/earned goals and, therefore, help achieve/exceed sales goals in the hospital segment. The rebate calculator application projects “potential” rebate opportunities based on a customer's purchasing performance during a partial rebate period. Along with the projections for total contract volume and rebate opportunities, there is a “what-if” capability for the participant to project what it might earn based upon buying choices it may make in that rebate period.

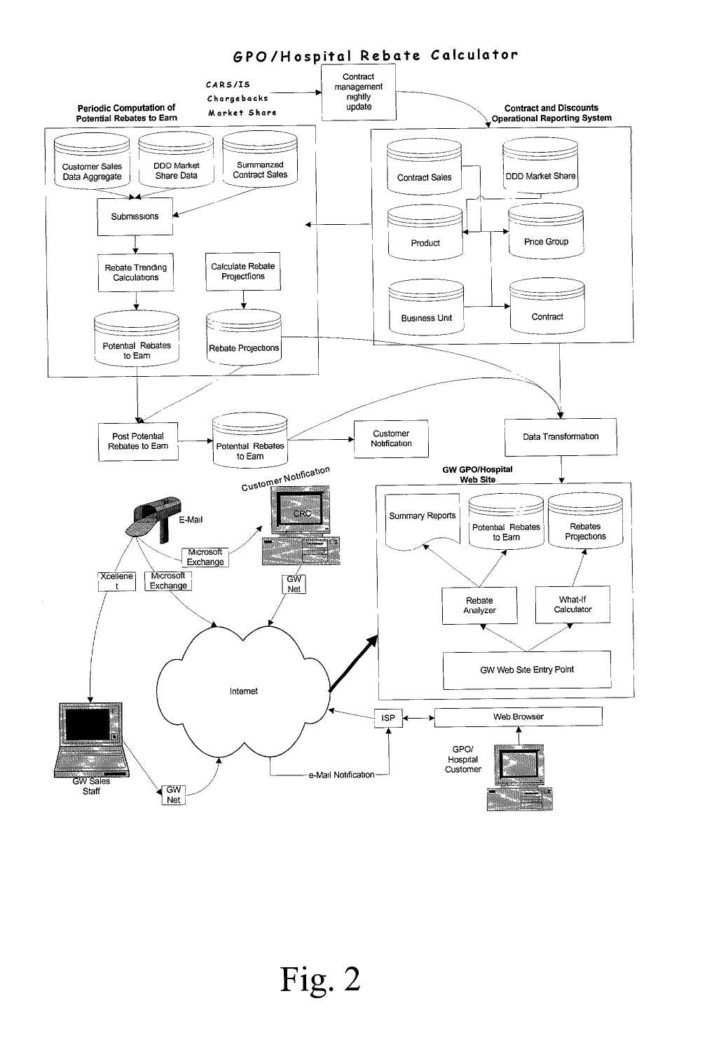

To facilitate that data analysis by customers and account agents, databases are generated to store market share data, contract and discount information and potential rebates to be earned. In a first embodiment such databases are updated and queried in real-time. In a second embodiment, as shown in FIG. 2, a snapshot of that data is periodically transformed and exported into a form accessible to an information server (e.g., Web server, FTP server or Gopher server) that is then queried by customers and/or account managers. In that second embodiment, the information server can either (1) query the data dynamically as requests arrive or (2) build a set of pre-calculated results for various possible queries. In fact, a single information server may pre-calculate the results of some queries (e.g., (1) the most commonly used queries across the entire system (but customized for each user) or (2) the most commonly run queries by each particular customer) but dynamically request unusual or infrequent requests.

As shown in FIG. 2, rather than requiring a customer to request data (e.g., using a pull technology such as a Web browser), information may also be sent to the user via a push technology (e.g., using e-mail notifications or facsimile delivery). Such “pushed” information may come from either an account administrator or the information server directly.

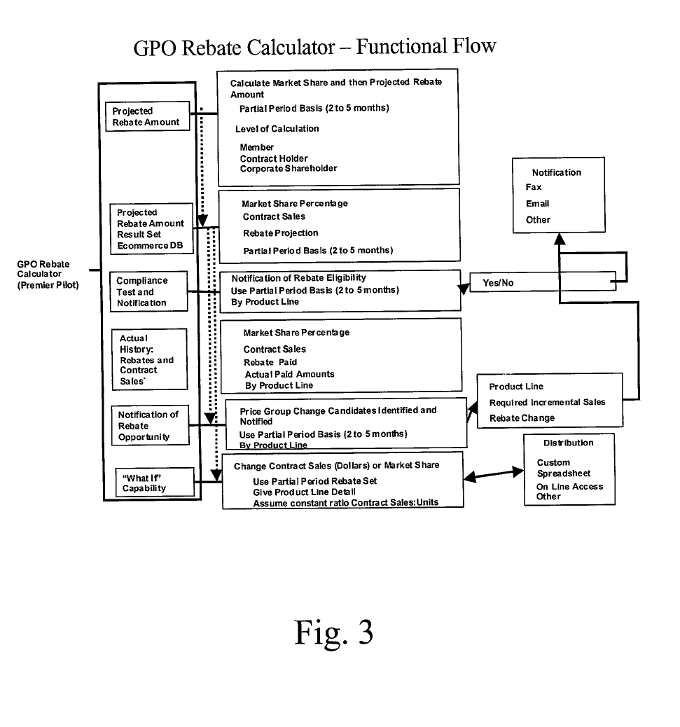

As shown in FIG. 3, projected rebate amounts are calculated automatically based on the available contract performance information (derived from sales and market share data) once a predetermined period rebate period (e.g., 3 months) has elapsed. Such a calculation is generally a hierarchical calculation in that rebates are available at member, contract holder and corporate shareholder levels. The “potential rebates to earn” calculation will occur periodically (e.g., monthly or weekly) from the initial trigger point throughout the remainder of the rebate cycle.

The calculations will be to the lowest level (i.e., to the member level) of a hierarchical participant and will have summary roll-ups to the highest level of the hierarchical participant. This enables individualized tracking at each level such that cooperative efforts can be made to achieve community goals.

At the election of the participant (or sub-participants), projected rebate amounts will be routed to a specific contact via either push or pull technologies, as discussed above. Information on providing Web services is provided in the following references which are incorporated herein by reference: (1) Visual Studio Core Reference Set, by Microsoft Press, (2) Visual InterDev 6.0: Web Technologies Reference, by Microsoft Press, (3) Professional Active Server Pages 2.0 by Francis et al., published by WROX Press Ltd., (4) Oracle PL/SQL Programming by Scott Urman, Published: March 1996, (5) Hitchhikers Guide to Visual Basic and SQL Server: with CD-ROM, by William Vaughn, Published: May 1997, (6) Using Microsoft SQL Server 6.5 (Special Edition) by Stephen Wynkoop, Published: March 1997, and (7) Advanced PowerBuilder 6 Techniques by Ramesh Chandak.

In addition to calculating the actual rebates due (based on market share percentage and contract sales), the system of FIG. 3 also identifies products that are price group change candidates (i.e., products whose price would appreciably change based on a foreseeable change in purchasing). Any products so identified would be brought to the attention of the contact(s) for the proper level(s), and changes based on the contact(s) are monitored.

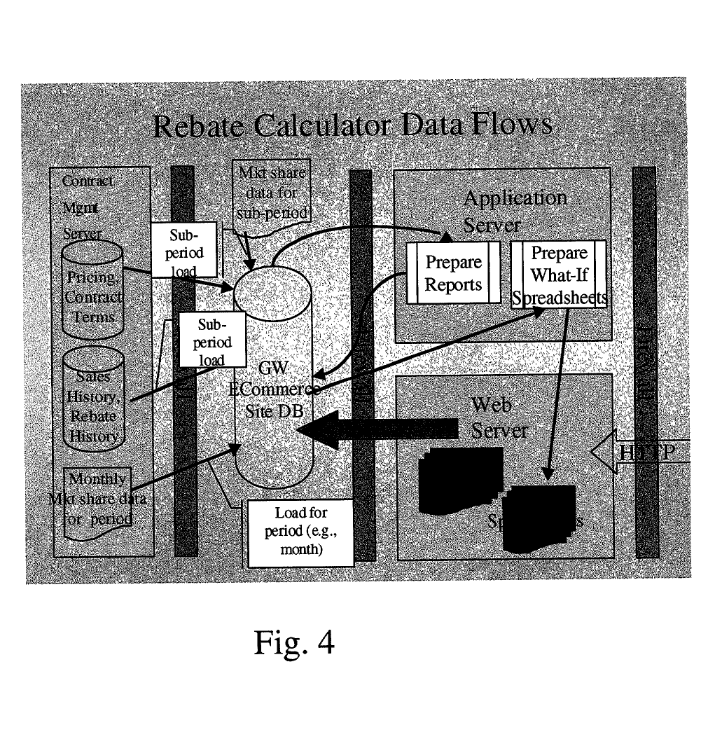

The data flow for one embodiment for achieving the above-described functionality is illustrated in FIG. 4. In the illustrated embodiment, snapshots of the data required to perform the summary and “what-if” calculations are posted to the databases of the external information server such that participants can access the data. In an alternate embodiment, the databases are replaced with standard files that are incorporated into the web site. Firewalls may optionally be placed between various components to increase the security of the overall system.

As shown in FIG. 4, generally a request is received using request transfer protocol (e.g., HyperText Transfer Protocol (HTTP), File Transfer Protocol (FTP), or Gopher Information Services). Those requests are received by an information server (e.g., Web server implementing a Web site) configured to listen to the corresponding type of request (e.g., HTTP requests). For requests for static information, such as general information and forms, that is independent of the user, the information server can satisfy the request directly. Some other requests, though, require that data be retrieved in order to respond to the request. The information server then queries a database (e.g., an eCommerce database) to provide the necessary information. In one embodiment, the data in the database is provided in real-time, and in an alternate embodiment, the data is a snapshot of the actual data stored in the eCommerce DB.

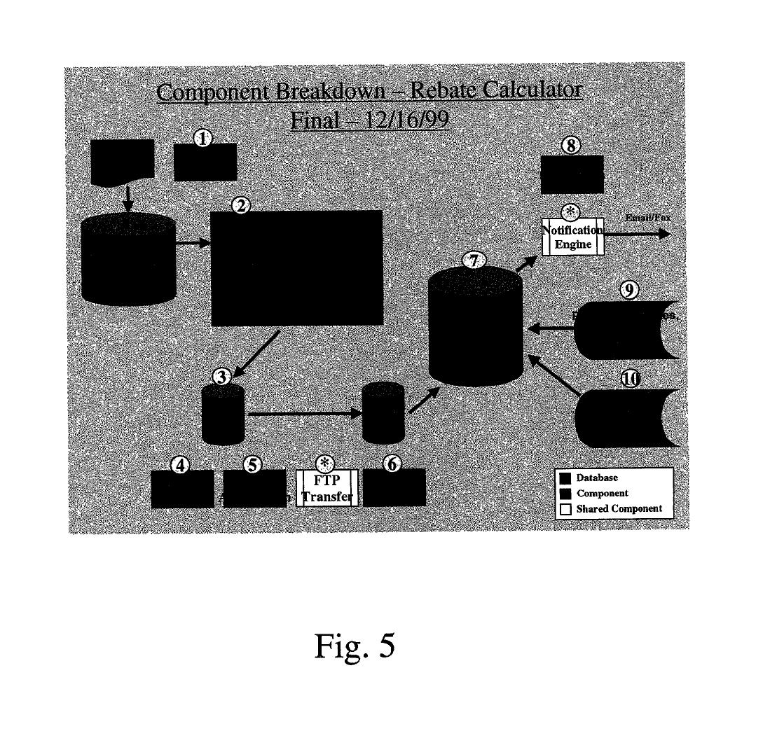

The snapshot data for use in the present invention is generated using the process of FIG. 5. As shown, data is exported, loaded and calculated at various times (which may be configurable) to achieve the functions of the present invention. The ten main functions are discussed below.

1. Period load of sales data: Data is loaded periodically (e.g., weekly, biweekly or monthly) into one or more separate tables. Newly developed code will validate the loaded data, and will permit reconciliation of the loaded with previously loaded data (e.g., if weekly data needs to be reconciled with monthly data).

2. Projected Rebate Calculations. This is a lengthy batch calculation process, which may be broken down into these steps:

a. Project Trend. Partial-period data (from monthly and weekly data, and from internal sales data) will be prorated to cover the full rebate period. The data to be computed will consist of those variables which drive rebates:

market share, contract sales, unit volume, and other measures.

b. Calculate projected rebates by product. The trended market share numbers (or other significant variables) will be combined with the internal trended contract sales numbers to arrive at a projected rebate amount by rebateable product.

c. Sum rebates. Projected rebates for all products will be summed by contract.

d. Compare projections to thresholds. “Thresholds” are breakpoints in the rebate calculation, represented on the contract price group table. They are levels of market share (or other measures) where the rebate calculation changes. If projected market share is near such a threshold, such that changes in customer buying patterns could drive a more favorable rebate, this process will identify the situation.

e. Calculate Rebate Opportunity. The calculation will be repeated with several hypothetical sets of input, representing market share for other measures) at more favorable levels. The resulting “opportunity” rebates will be compared to the “projected” rebates, along with the required changes to purchasing behavior to achieve the “opportunity” rebates. The purpose of this calculation is to highlight to the customer the incremental rebates they could achieve by making relatively small changes to their buying patterns.

f. Store Results. The results of these calculations will be written to a flat file or a database for storage on the Web site.

3. Flat file extracts: Flat files, containing the results of the rebate calculations along with any data aggregates necessary to drive the what-if calculations, will be FTP'd to the Web site.

4. Database Extraction: Additional contract management data, such as the contract price group tables, market share, contract sales and rebate history data, will be extracted from the contract management database.

5. Data aggregation: Some of the contract management data, such as market share, may be pre-aggregated to reduce the data volume to be sent to the site.

6. FTP Transfer/Database Load: The various flat files will be FTP'd to the Web site and loaded into the site database.

7. Site Database: The Web site's database will contain the information generated by the rebate calculation process (step 2), along with extracted contract management data and other information (such as contract membership information, for authorization purposes).

8. Notifications: Site users will be notified of rebate opportunities. These notifications will take the form of a brief email containing a link back to the Web site, where the users will be able to review their projected and opportunity rebate levels.

9. Projected Rebates, Compliance Inquiry: Site users will have several pages to inquire on: a) contract compliance or non-compliance; b) projected rebates; c) opportunities to increase rebates by changing purchasing patterns. Intended users are both external site users, and sales personnel reviewing the data on behalf of their customers.

10. What-If Analysis: Site users will have several pages allowing them to propose different values for market share (or other measures that drive calculated rebates) for the current rebate period. These pages will calculate an approximate resulting rebate amount using the user's input in place of the computed values. Intended users are both external site users and sales personnel.

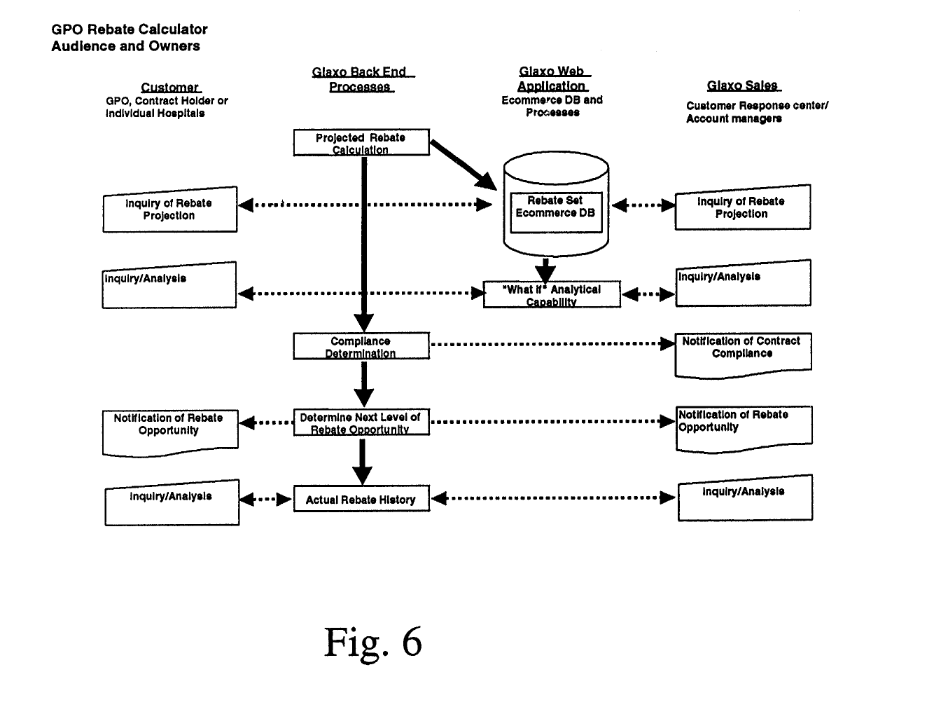

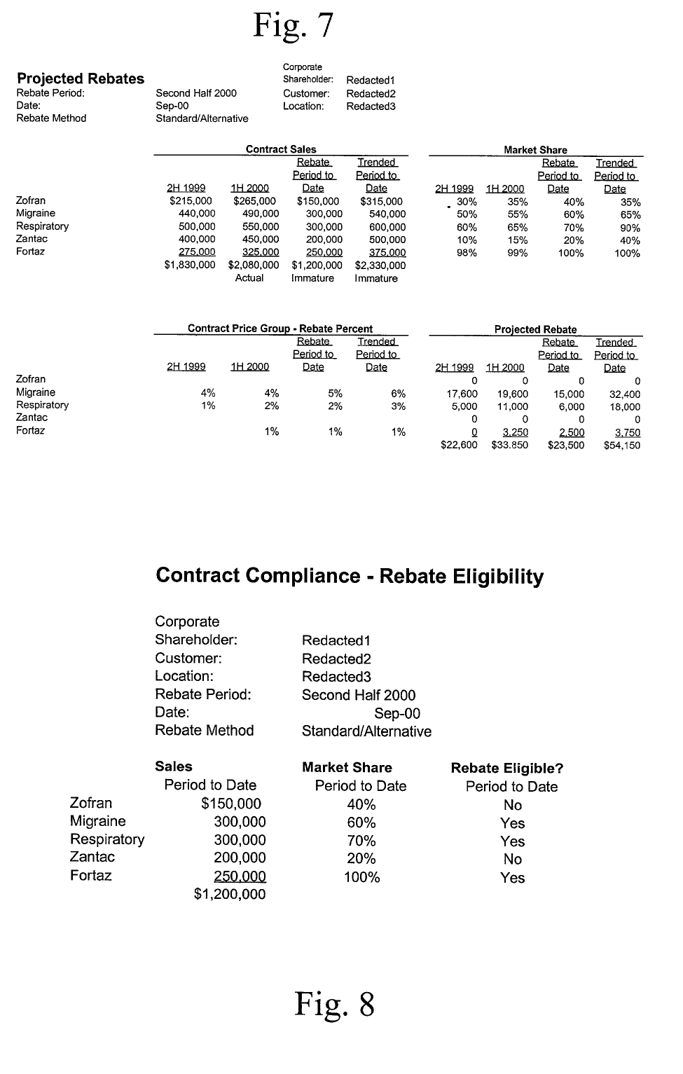

An alternate method of looking at the data flow diagrams of FIGS. 4 and 5 is illustrated in the workflow chart of FIG. 6. An application back end facilitates calculation and analysis of projected rebate calculations, compliance checks, opportunities for next levels of rebates, and histories of actual rebates.

The customer and the manufacturer may review the projected rebates on-demand on the Web site. Based on this review, a participant, GPO and corporate shareholder will be notified (e.g., via e-mail or other push technology) if the account is projected to be out of compliance with the governing contract terms and conditions (see FIG. 8). Additionally, the contents of that same notification will be routed to the designated GW staff covering the account (i.e. the National Account Manager, the Medical Center Representative, or the Customer Response Center representative), either using the same delivery technique or another.

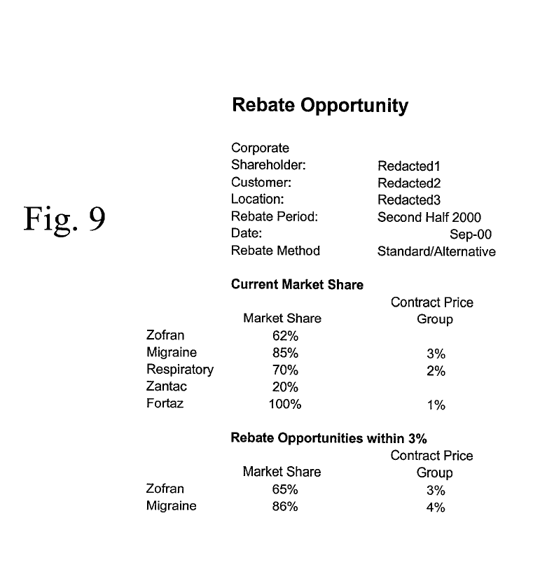

Upon reviewing projected rebates and sales figures, the Account Manager and appropriate sales person are notified if a customer is within a certain specified percent (e.g. 3%) of the next rebate price group (see FIG. 9). This information will include all the pertinent fields; contract sales, market share percentage, rebate price group, and estimated rebate by product line. This information can be sorted as desired by management in a spreadsheet to identify where and what effort will give the distributor or manufacturer the most benefit. Similarly, if the customer's sales performance is within a certain percentage of qualifying it for a better rebate level, it will be notified of the amount of incremental sales that would result in improved rebates.

“Rebate Opportunity” Capability

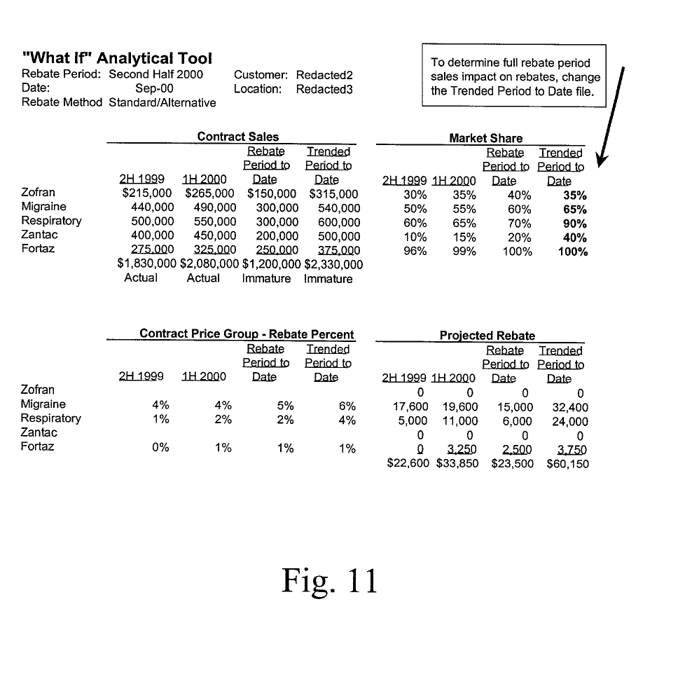

“Rebate opportunity” analyses (or “What-if” analyses) (e.g., using a Web site or an active control (e.g., a Java or Active-X control)) may be performed to view the impact of potential changes in purchasing patterns (see FIG. 11). (This information may be viewed at any level. The manufacturer, the distributor, the wholesaler, the retailer, the buying group manager and the end customer, may all have various levels of access to this information. As would be appreciated by one of ordinary skill in the art, different interfaces and data may be available to each viewer.) To support this what-if analysis capability, the back-end process computes the full complement of data points for potential rebates to earn. This includes minimums through maximums for each contract holder for each eligible contract member for each active contract. The result set of data points are loaded to the database to be the data source for the what-if analysis.

Actual History Rebates and Contract Sales

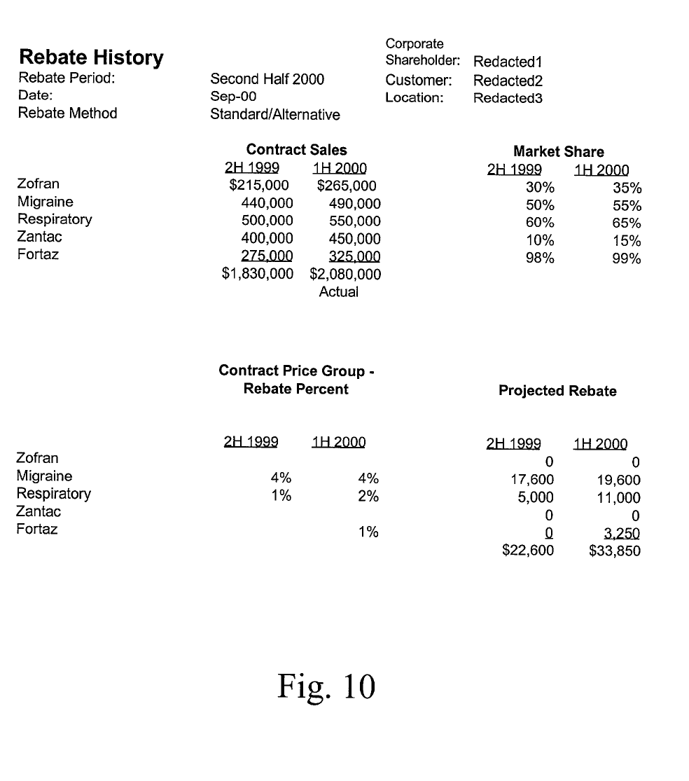

As shown in FIG. 10, historical purchasing and actual rebates earned information (e.g., using the Web site or an active control) may be viewed. (This information may be viewed at any level. The manufacturer, the wholesaler, the distributor, the retailer, the buying group manager and the end customer, may all have various levels of access to this information. As would be appreciated by one of ordinary skill in the art, different interfaces and data may be available to each viewer.) This information will be available in various forms (e.g., tabular reports, trending charts, etc.) and can be extracted for download (e.g., to Microsoft Excel based spreadsheets or a generic data file format).

Operation of System

Generally, data is generated and loaded into various databases in a distributed embodiment of the present invention. The rebate calculator's features require functions complementary to the current rebate payment methodology. Information is loaded into a contract management system periodically (e.g., nightly, bi-weekly, or weekly, or a combination thereof). This stores into the contract management system: (1) Contract Sales, (2) Market Share, (3) Product information, (4) Contract Price Group information, (5) Contract information, (6) Business Unit information.

The Chargeback and Sales system information is used to calculate rebates at the end of rebate cycle. Regarding market share data, the limiting factor is the availability of market share data. It is available some time (e.g., 2 months) after the close of a period, and typically has to be reformatting before being entered. Thus, after the end of the period, the data is ready to be run through the actual rebate payment calculation.

Rebates are calculated using rebate payment percentages of actual contract sales of specific products. The appropriate rebate percentage is a function of the market share of qualifying products (e.g., products of a particular distributor or manufacturer) within a product group, or “Market Basket”. Their market share data is the same used to generate Therapeutic Class Reports (TCR) for sales territory market share.

The actual calculations are specific to each contract. Each product may or may not be subject to rebate payments. Also, other parameters come into the equation. Market share rebates may be warranted except for a customer not being in compliance with other aspects of their contract; e.g. formulary membership. Other contracts have additional parameters imposed on the rebate calculation (e.g., incentives to use additional products by the same manufacturer or distributor). Non-compliance of an entity with a specific contract will result in notification being sent to the appropriate National Account Manager. As the rebate calculator is rolled out to other GPO's, account managers, Sales and Customer Response Center people will be notified as determined appropriate.

Market share information is obtained as a data feed and loaded within the contract management system periodically (e.g., on a weekly or monthly basis). The rebate calculator is to compute market share more frequently (e.g., on a bi-weekly or weekly basis). The immaturity of that information is accepted with the assumption that all competitor information is immature to the same degree as customer information.

Market share is to be computed regularly (e.g., weekly) with this information. The start will be the beginning of each rebate period. Weekly information will be used until the normal monthly DDD data is used, and it will replace the weekly data for the time period it covers. This weekly data will continue to be used until the final rebate calculation, three months after the end of the rebate period.

With market share calculated, a rebate can be projected. The methodology to do this currently is averaging the rebate period-to-date by month and then multiplying by the time (e.g., six months) included in a rebate period. From this, information about what rebate opportunities can be attained is to be highlighted by looking at all opportunities that are within three percent of reaching the next rebate contract price group level. This information is kept in the E-commerce database and made accessible to appropriate management.

Input Requirements

Various inputs are used to perform the tracking of the present invention. Examples include: (1) third party data to calculate market share, (2) contract sales to calculate the rebate payment, and (3) contract terms and conditions to ensure that the correct third party data and contract sales information is used correctly to both compute market share, determine targets, opportunities or compliance, decide calculate payment with the “to date” performance, and forecast rebate payments based on changes in buying behavior.

Online Requirements

Availability of information for an individual contract will be based upon the active contract member eligibility and the linkage to the access profile information as managed in the security application that will secure the site. General business rules for the customer are as follows:

The GPO contract holder may review data at any detail within its eligible membership and including any rollups provided. If there is a corporate shareholder in the hierarchy, the corporate shareholder may see any of its eligible memberships and including any memberships provided. At the lowest level, the eligible contract member may see its data only and any rollup provided.

Customers may limit access to certain staff within the organization. Such access restrictions may be managed through either a local security application (e.g., that administers a participant's access rights to the web site) or a remote security application running on the Web site.

Processes

The rebate calculator processes need contract specific data and business rules to get started. Market share data will come from DDD and be used to determine a distributor's or manufacturer's market share by product. This market share information will be combined with contract sales data to compute a projected rebate using contract terms and conditions that are embodied within business rules.

Timing of these calculations will affect how often a projected rebate result set is calculated and the credibility of that calculation. In one embodiment, the information is procured monthly and not shared with the client until it is the time to calculate and pay a rebate. The DDD market share data and contract sales data is considered immature until three months after a rebate period has ended. The market share data needs that much time to be fully collected by IMS, collated and scrubbed by them, supplied to the distributor or manufacturer, and then stored for the market share calculation. Contract sales are immature until all appropriate chargebacks are applied. Ninety percent of chargebacks are applied within thirty days, so DDD data is the limiting factor.

For any given contract, market share is to be calculated weekly with DDD data. The move to weekly updates has two reasons. First, purchase behavior has a time lag, and immature information is better than none to induce action by the customer to increase their purchase of products from the distributor or manufacturer. The relative market share is not expected to be much different than that using mature market share information. Second, weekly information is perceived as a competitive advantage. No other pharmaceutical is giving market share information in that periodicity.

The E-commerce Database will be the repository for the current Projected Rebate Result set, and it will be replaced weekly after new data is run through the algorithms. That new data will be used to:

1) Calculate the current period-to-date rebate with immature information.

2) Project the current period-to-date rebate into a fall period estimate.

3) Estimate the prior period rebate using must current information.

4) Exhibit the past prior period actual rebate payment.

With each passing week, more mature information will be available for calculations. At the beginning of a rebate period, the immaturity of this information makes any full period projection not credible. Given this, no projection will be shared with customers until the rebate period is two months old and all the weekly data for that period has been run through the market share and rebate algorithms.

The prior rebate period will be updated with information germane to that period during the current rebate period. With each passing month, the monthly data used in the current process will supplant that of the weekly in the calculation of market share and so estimated rebate payment. Three months into the current rebate period, the prior rebate period will be finalized and the actual payment will be calculated. This calculation will serve as an audit to the algorithms used by Rebate Calculator.

Outputs

The present invention provides several outputs to help in the tracking of rebates. These include:

Projected Rebate Amount: Two months into a new rebate period, a projected rebate for the entire period will be calculated.

Compliance Test and Notification: A report of who is in and out of compliance is to be made available to all sales people. The sales person is responsible for informing the customer and taking action on the information.

Notification of Rebate Opportunity: The sales people will be notified when accounts are within three percent of meeting the next contract price group rebate percentage. This information will be recalculated and updated weekly so that there will be time available to get customers to recognize the rebate opportunity and to change their buying behavior in time to attain that next rebate level.

Actual Rebate History: Contract Sales, Market Share percentage, Contract Price Group rebate percentage, and actual paid rebate by product line will be kept on available on the E-commerce DB for the past two complete rebate periods. This information will be used for budgeting of pharmaceutical purchases and rebate accrual by customers, and reference information for sales.

“Rebate Opportunity” Analysis: The projected rebate result set will be used to drive the sensitivity analysis engine. A report (e.g., spreadsheet or Web page) for each entity will be generated with the result set and a capability to change the market share to understand how sales must change in order to attain the next level of rebate, i.e. attain the next higher contract price group. This analysis engine lets the customer go up and down the rebate tier structure to evaluate optimistic and pessimistic performance.

Critical Success Factors/Metrics

Success Factors or Metrics require access to timely data. Obtaining the data used to calculate market share, before the close of rebate period rather than after the close of the rebate period, is necessary to have the rebate calculator be an effective tool to achieve the contract goals and objectives.

The rebate calculator will subject the contracts to be interpreted to a much finer degree of detail than previously. This demands that the algorithms used in the actual calculation match those in the actual rebate calculator engine used to calculate payments. The rebate opportunity calculations will be tightly coupled with the rebate payment engine to insure the integrity and consistency of the calculations.

The contract terms and conditions are proprietary and confidential. Customer access must be controlled on the hospital, corporate shareholder, and GPO levels. Failure to segregate access will generate discontent and concern that can easily outweigh any benefits of the rebate calculator. Internal and customer feedback and complaints will determine if this goal is being met.

The current rebate calculation sensitivity analyses are done now only on a limited, ‘ad hoc’ basis by the account management staff. The customers and clients must be taught both the uses of the rebate calculator, and the relationships between rebates earned and customer buying behavior.

Immediate feedback, enhances the utility of this tool for participants. By pre-calculating the what-if data points and then storing them in a database, the time delay inherent with on-line calculations of the complexity involved in rebates earned determination can be mitigated.

As would be understood by one of ordinary skill in the art based on the present specification, the use of flat files can be replaced with extracting data from a database. One advantage of this technique is the centralized manipulation of data by one or more components using the same database engine.

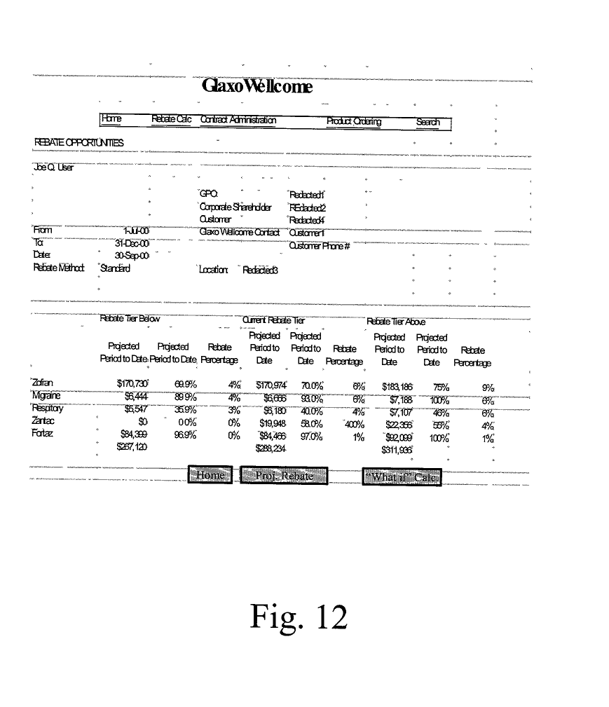

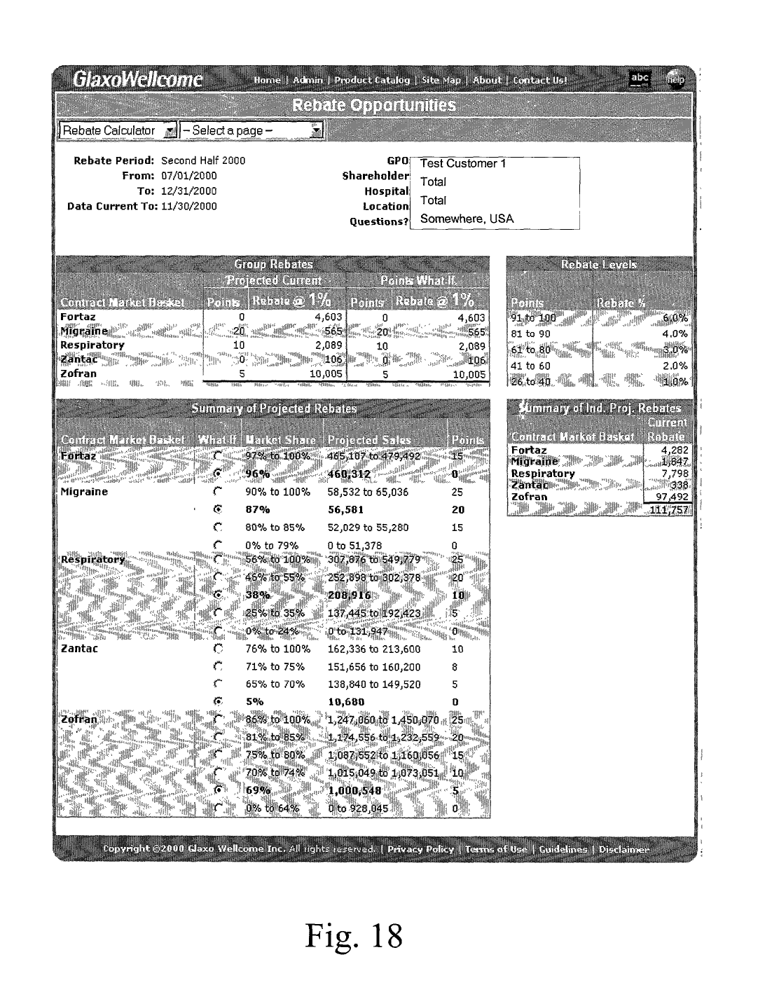

An exemplary screenshot of a spreadsheet showing a current tier analysis as compared to adjacent tiers above and below the current tier is shown in FIG. 12. Using the rebate opportunity calculator, additional market share-based rebate scenarios can be computed for various hierarchical levels. An alternate exemplary interface is illustrated in FIG. 18.

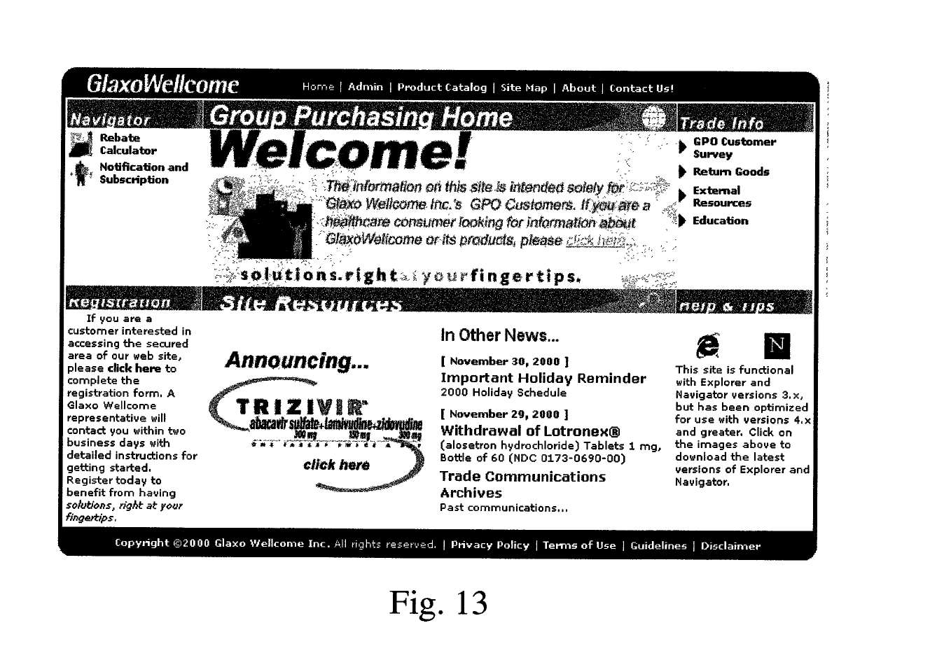

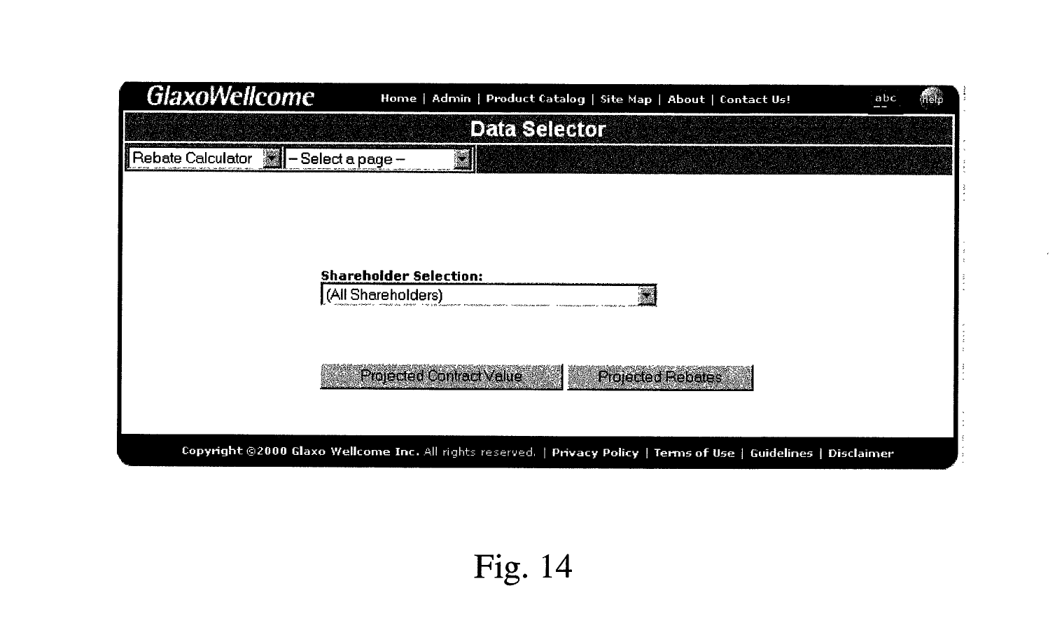

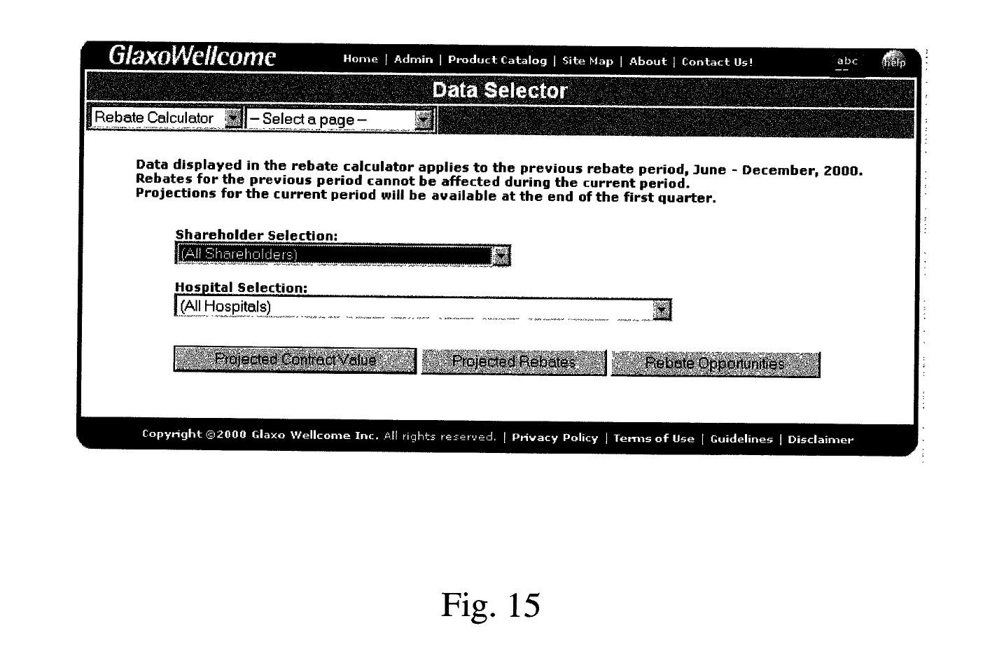

Using a Web-based (as opposed to spreadsheet-based) interface, a customer or seller (or anyone else in between in the sales chain) can view a number of different sets of information about projected sales and rebates. FIG. 13 illustrates a beginning Web page that acts as the home page for a purchasing plan. The user can select the rebate calculator icon from this interface to be provided with a group selection screen, such as is shown in FIG. 14. By selecting a group, a user can then select a sub-group (e.g., a hospital belonging to a previously selected shareholder group), such as is shown in FIG. 15. Using that interface, the user can select a projected contract value, projected rebates or rebate opportunities.

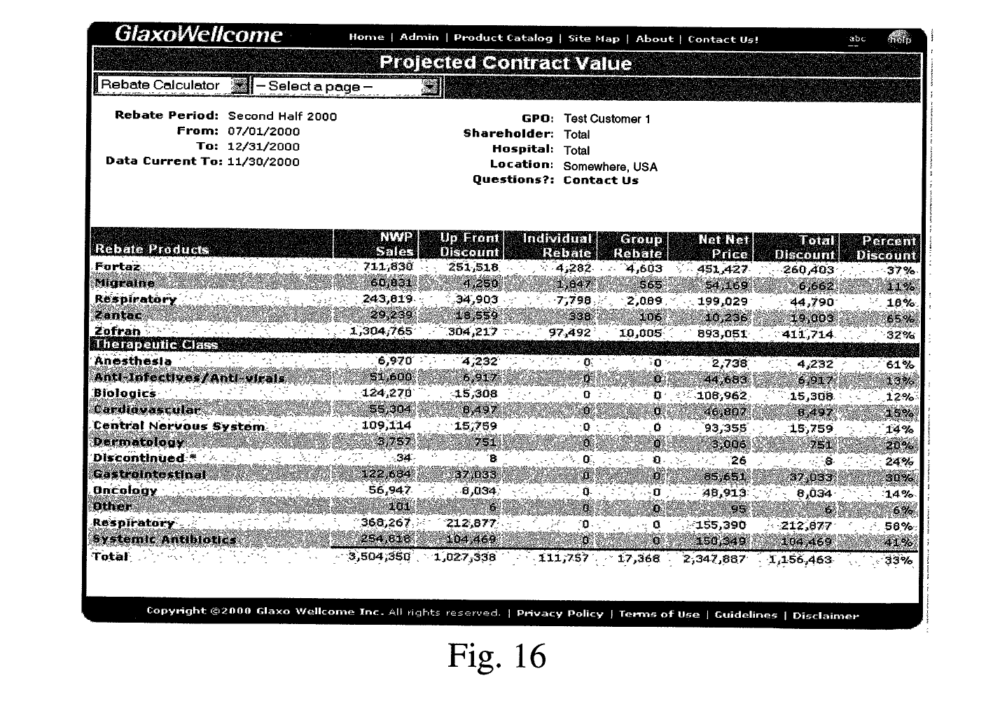

FIG. 16 illustrates a partially redacted interface that includes a projected contract value for the selected group/sub-group of FIG. 15. The rebates are illustratively broken into products and classes, but it should be appreciated that other divisions are also possible.

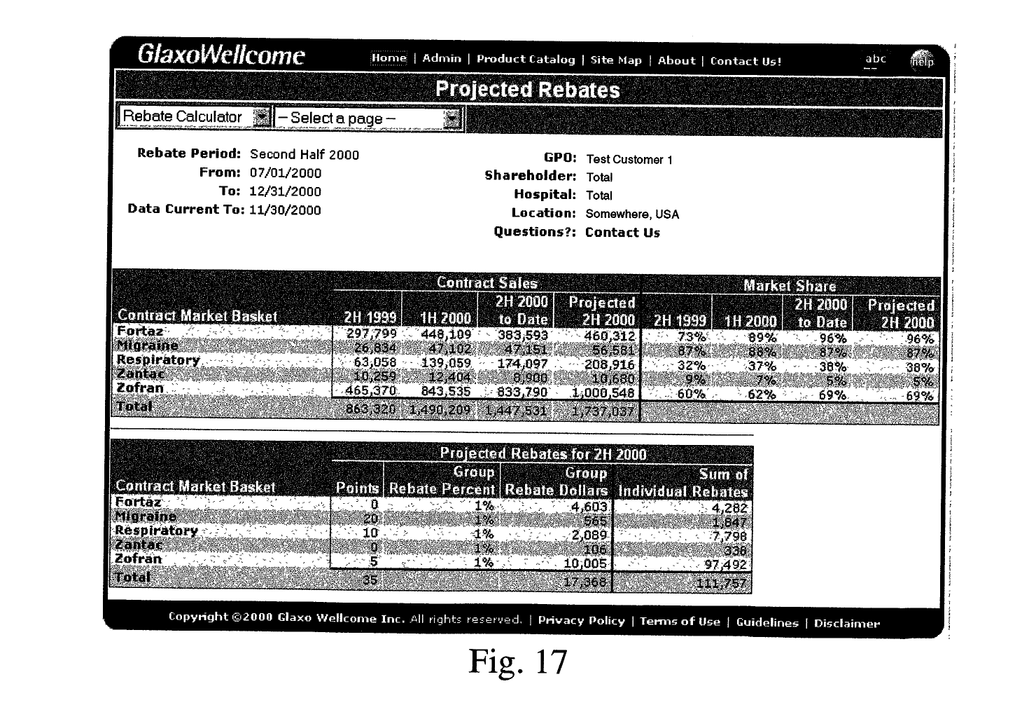

Using collected data, the system can also project rebates over specifiable periods. For example, as shown in FIG. 17, projected rebates for an upcoming period may be made based on recently collected data. Such projections may be displayed against similar previous periods. Projections can also take the form of “what if” projections, as shown in FIG. 18 and discussed above.

Obviously, numerous modifications and variations of the present invention are possible in light of the above teachings. It is therefore to be understood that, within the scope of the appended claims, the invention may be practiced otherwise than as specifically described herein.

1. A computer program product, comprising:
a computer storage medium and a computer program code mechanism embedded in the computer storage medium for causing a computer to control an analysis of compliance with a contract, the computer program code mechanism comprising:
a first computer code device configured to read in rules associated with a contract;
a second computer code device configured to read in performance milestones associated with the rules of the contract; and
a third computer code device configured to compare the performance milestones against the rules of the contract.

2. The computer program product as claimed in claim 1, wherein the third computer code device comprises a fourth computer code device configured to measure if a participant is entitled to a rebate.

3. The computer program product as claimed in claim 1, wherein the third computer code device comprises a fourth computer code device configured to measure if a participant is in breach of a contract sales amount.

4. The computer program product as claimed in claim 1, wherein the third computer code device comprises a fourth computer code device configured to measure if a participant is within a predetermined amount of achieving a next milestone.

5. The computer program product as claimed in claim 4, wherein the fourth computer code device comprises a fifth computer code device configured to send a notification to a sales representative if a participant is within a predetermined amount of achieving a next milestone.

6. A computer-implemented method comprising:
reading in rules associated with a contract;
reading in performance milestones associated with the rules of the contract; and
comparing the performance milestones against the rules of the contract to determine contract compliance.

7. The computer-implemented method as claimed in claim 6, wherein the comparing step comprises measuring if a participant is entitled to a rebate.

8. The computer-implemented method as claimed in claim 6, wherein the comparing step comprises measuring if a participant is in breach of a contract sales amount.

9. The computer-implemented method as claimed in claim 6, wherein the comparing step comprises measuring if a participant is within a predetermined amount of achieving a next milestone.

10. The computer-implemented method as claimed in claim 9, wherein the measuring step comprises sending a notification to a sales representative if a participant is within a predetermined amount of achieving a next milestone.

11. The computer-implemented method as claimed in claim 9, wherein the measuring step comprises sending a notification to a participant if a participant is within a predetermined amount of achieving a next milestone.

12. A computer-implemented method comprising:
reading in rules associated with a contract;
reading in performance milestones associated with the rules of the contract;
measuring if a participant is within a predetermined amount of achieving a next milestone; and
notifying at least one of a participant and a contract manager of an amount needed to achieve the next milestone.

13. The computer-implemented method as claimed in claim 12, further comprising:
measuring if a purchasing behavior is modified based on the step of notifying.

14. A computer-implemented method comprising:
reading in rules associated with a contract;
reading in performance milestones associated with the rules of the contract;
reading in a current compliance level with the contract;
displaying the current compliance level with the contract;
simulating a change in the current compliance level to a modified compliance level;
displaying a rebate opportunity associated with the modified compliance level.

15. The computer-implemented method as claimed in claim 14, wherein the step of simulating comprises simulating a change by decreasing an amount of purchases.

16. The computer-implemented method as claimed in claim 14, wherein the step of simulating comprises simulating a change by increasing an amount of purchases.
